(19) United States
(12) Patent Application Publication
(10) Pub. No.: US 2009/0012788 A1
(43) Pub. Date: Jan. 8, 2009

(54) SIGN LANGUAGE TRANSLATION SYSTEM

(76) Inventors: Jason Andre Gilbert, Ypsilanti, MI (US); Shau-yuh YU, Ann Arbor, MI (US)

Correspondence Address: SCHOX PLC, 730 Florida Street #2, San Francisco, CA, 94110, US

(21) Appl. No.: 12/167,978

(22) Filed: Jul. 3, 2008

Related U.S. Application Data
(60) Provisional application No. 60/947,843, filed on Jul. 3, 2007.

(51) Int. Cl. G10L 15/26

(52) U.S. Cl. 704/235; 704/E15.001

(57) ABSTRACT

The translation system of a preferred embodiment includes an input element that receives an input language as audio information, an output element that displays an output language as visual information, and a remote server coupled to the input element and the output element, the remote server including a database of sign language images; and a processor that receives the input language from the input element, translates the input language into the output language, and transmits the output language to the output element, wherein the output language is a series of the sign language images that correspond to the input language and that are coupled to one another with substantially seamless continuity, such that the ending position of a first image is blended into the starting position of a second image.

### CROSS-REFERENCE TO RELATED APPLICATIONS

This application claims the benefit of U.S. Provisional Application No. 60/947,843, filed 3 Jul. 2008 and entitled “SIGN LANGUAGE TRANSLATION SYSTEM”, which is incorporated in its entirety by this reference.

### TECHNICAL FIELD

This invention relates generally to the language translation field, and more specifically to an improved system to translate between spoken or written language and sign language.

### BACKGROUND

There are several million people that are deaf or hard of hearing. These individuals often cannot communicate effectively in situations when an interpreter is not available and the individual must communicate with another individual that does not sign. Additionally, these individuals may have difficulty listening in classrooms or conferences, ordering in restaurants, watching TV or movies, listening to music, speaking on the telephone, etc. Current solutions include communicating with pen and paper; however, this method is quite slow and inconvenient. Furthermore, some hard of hearing individuals may have difficulty communicating with written language as there is no commonly used written form of sign language. Thus, there is a need for an improved system to translate between spoken or written language and sign language. This invention provides such an improved and useful system to translate between spoken or written language and sign language.

### BRIEF DESCRIPTION OF THE FIGURES

FIG. 1 is a representation of the translation system of the first preferred embodiment of the invention.

FIG. 2 is a schematic block diagram of a method of translating speech to text and sign language.

FIG. 3 is a schematic block diagram of a method of translating sign language to speech and text.

FIG. 4 is a schematic block diagram of a method of sign language video capture.

### DESCRIPTION OF THE PREFERRED EMBODIMENTS

The following description of preferred embodiments of the invention is not intended to limit the invention to these embodiments, but rather to enable any person skilled in the art to make and use this invention.

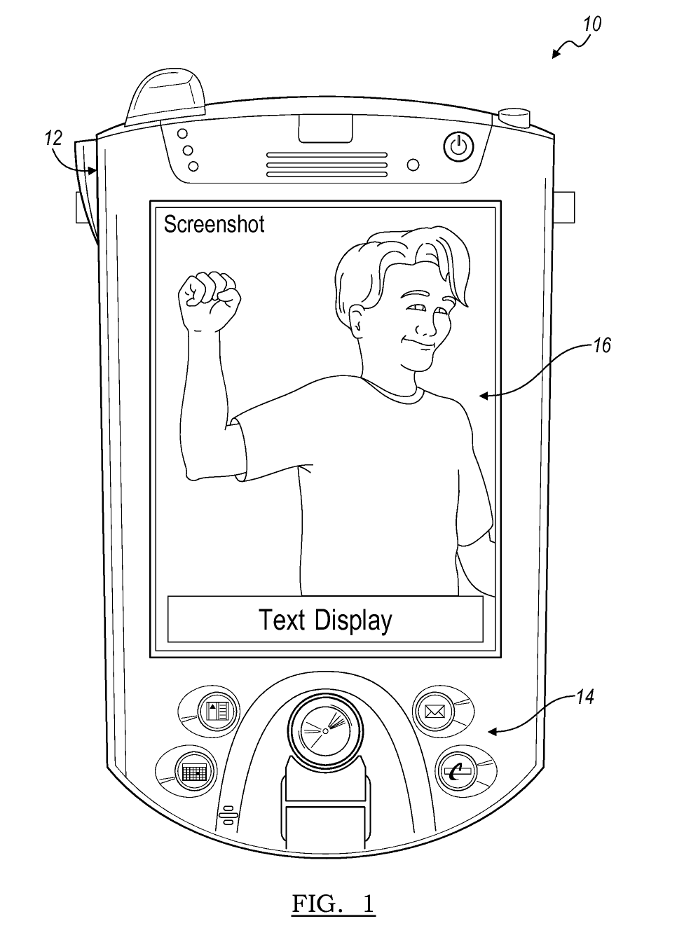

As shown in FIG. 1, the translation system 10 of the preferred embodiments includes a device 12, an input element 14 adapted to receive the input language to be translated, an output element 16 adapted to transmit the translated output language, and a processor coupled to the input element 14 and the output element 16 and adapted to receive the input language from the input element 14, translate the input language to the output language, and transmit the output language to the output element 16. The translation system 10 is preferably designed for language translation, and more specifically for translation between spoken or written language and sign language. The translation system 10, however, may be alternatively used in any suitable environment and for any suitable reason.

The device 12 of the preferred embodiments is preferably one of several variations. In a first variation, as shown in FIG. 1, the device 12 is a personal digital assistant (PDA). The device 12 in this variation is preferably any conventional PDA that can access the Internet and may also function as a calendar, mobile phone, web browser, portable media player, etc. In a second variation, the device 12 is a mobile phone. The device 12 in this variation is preferably any conventional mobile phone that can access the Internet. In a third variation, the device 12 is a laptop computer. The device 12 in this variation is preferably any conventional laptop computer that can access the Internet. In a fourth variation, the device 12 is a media player. The device 12 in this variation is preferably any conventional media player that can access the Internet. In a fifth variation, the device 12 is a desktop computer. The device 12 in this variation is preferably any desktop computer that can access the Internet. Additionally, the device 12 in any of these variations may be Bluetooth enabled. Although the device 12 is preferably one of these five variations, the device 12 may be any suitable Internet capable device.

### 1. The Input Element of the Preferred Embodiments

As shown in FIG. 1, the input element 14 of the preferred embodiment functions to receive the input language to be translated. The input element 14 is preferably one of several variations. In a first variation, the input element 14 includes a camera that functions to record video and/or still frame information. The camera is preferably a conventional camera that records visual light waves, but may be any suitable device able to record images (using visual light waves, IR waves, or other suitable methods). The input element 14 may be coupled with an illumination device, such as a spotlight, that can emit visual light waves, IR waves, or other suitable waves. In this variation, the input language is preferably images or video of sign language, facial expressions, and/or lip movements to be read for lip reading. Sign language may be American Sign Language (ASL), Pidgin Signed English (PSE), Signed English, Signing Exact English (SEE), or any other suitable signed language. The input language in this variation is preferably captured as video by a camera input element 14 as described above, but may alternatively be captured directly as data. The latter would be accomplished by the signer performing each sign using motion capture equipment, data gloves, or other data input device. The motion capture equipment preferably includes several markers placed around the person's hands and body or motion capture gloves wherein the movement of each marker or the movement of the gloves is recorded as data. The motion capture equipment may alternatively include marker-less motion capture technology.

In a second variation, the input element 14 includes a microphone that functions to record audio information. The microphone is preferably a conventional microphone, but may be any suitable device able to record sound. The input element 14 in this variation may connect to a hearing aid device, a telephone, a music player, a television, and/or a microphone or speaker system in a conference room, lecture hall, or movie theater and receive the input language directly from one of these devices. The input language of this variation is preferably spoken language, but may also be environmental sounds, music, or any other suitable sound or input language. The input element 14 in this variation is preferably voice independent and preferably does not require individual speech/voice recognition (S/VR) files to be created for each individual voice in order for the input language of each individual to be recognized.

The input element 14 of a third variation is adapted to receive data input (in the form of text input). The input element 14 of this variation is preferably a keyboard adapted to receive text input. Alternatively, the input element of this variation is a touch screen that is able to receive text input by use of a virtual keyboard shown on the touch screen or by letter or word recognition, wherein letters or words are written on the touch screen in a method known in the art as “graffiti”. The input element 14 in this variation may additionally include buttons, scroll wheels, and/or touch wheels to facilitate in the input of text. Text may also be received by the input element 14 by selecting or highlighting text in electronic documents. Text may also be received by the input element 14 by deriving it from closed captioning. The input language of this variation is preferably written language. Although there are certain advantages to these particular variations, the input element 14 may take any suitable form.

### 2. The Output Element of the Preferred Embodiments

As shown in FIG. 1, the output element 16 of the preferred embodiment functions to transmit the translated output language. The output element 16 of the preferred embodiment is preferably any suitable device adapted to display the translated output language. In a first variation, as shown in FIG. 1, the output element 16 is a screen. The screen is preferably a conventional screen that displays images or text, but may be any suitable device able to display images or text. The output language is preferably transmitted by the output element 16 and displayed in a browser or other suitable Internet application (such as an SMS or MMS application). The output language displayed on the screen in this variation is preferably video image, still frame image, and/or text. The video image is preferably a series of animations i.e. sign language, that match the input language such as written or spoken language. Sign language may be American Sign Language (ASL), Pidgin Signed English (PSE), Signed English, Signing Exact English (SEE), or any other suitable signed language. The animations are preferably displayed with substantially seamless continuity leading to improved comprehension. The output language in this variation may additionally be adjusted, either automatically or by the user, to improve comprehension. For example, the speed of the video may be slowed down or sped up, the camera angle of the video may be altered, the character or avatar in the video may be selected or altered, or any other suitable changes may be made. The screen may display the translated output language in a split screen format. For example, one screen may display the output language in text format while another screen may display the output language in video sign language format. Additionally, if there is more than one individual speaking or signing, the translated output language from each individual may be displayed in a separate screen and/or by a separate avatar.

The output element 16 of the second variation is a speaker. The speaker is preferably a conventional speaker, but may be any suitable device able to transmit sound. The output language transmitted through the speaker in this variation is preferably spoken language such as a computer-generated voice. The computer-generated voice may be a male or female voice, and both the pitch and speed of the voice may be adjusted, either automatically or by the user, to improve comprehension. Additionally, the output element 16 in this variation may interface with hearing aid devices, telephones, FM systems, cochlear implant speech processors, or any other suitable device.

### 3. The Processor of the Preferred Embodiments

The processor of the preferred embodiment is coupled to the input element 14 and the output element 16 and is adapted to receive the input language from the input element 14, translate the input language to the output language, and transmit the output language to the output element 16. The processor may be located within the device 12 or may be located on a remote server accessed via the Internet or other suitable network. The processor is preferably a conventional server or processor, but may alternatively be any suitable device to perform the desired functions. The processor preferably receives any suitable input language and translates the input language into one or more desired output languages. Some suitable input and output languages include images or video of sign language, facial expressions, and/or lip movements; spoken language; environmental sounds; music; written language; and combinations thereof.

In the case of the output language as images of sign language, the processor preferably translates the input language to the output language and transmits the output language to the output element 16 as a series of animations that match the input language. The animations are displayed with substantially seamless continuity leading to improved comprehension, i.e. the ending of one animation is preferably blended into the beginning of the next animation to ensure continuity between signs. The continuity is preferably achieved without the need for a standard neutral hand position at the beginning and end of each sign language animation. Seamless continuity is preferably obtained by calculating the ending position of a first sign and then calculating the starting position of a subsequent sign. The motion from the ending position of a first sign to the starting position of the second sign is interpolated, preferably using an interpolated vector calculation, but may be alternatively calculated using any other suitable calculation or algorithm. By calculating the motions between signs the transition between signs is smoothed.

The processor may further function to connect multiple devices 12. The devices 12 may be connected through a system of wires, or preferably, by means of a wireless device. The wireless device may function to connect any suitable combination of devices 12, input elements 14, output element 16, and processors. The wireless device may function to connect the devices 12 to other adjacent devices 12, or may function to connect the devices 12 to a larger network, such as WiMAX, a ZigBee network, a Bluetooth network, an Internet-protocol based network, or a cellular network.

The processor may also access and/or include reference services such as dictionaries, thesauruses, encyclopedias, Internet search engines, or any other suitable reference service to aid in communication, comprehension, and/or education. Additionally, the written text of any suitable reference may be translated by the processor into sign language and/or spoken language.

The processor may also access and/or include a storage element. The storage element of the preferred embodiment functions to store the input language from the input element 14 and the output language from the output element 16 such that the storage element may store conversations for future reference or for education purposes. Additionally, the conversations may be archived and accessed at a later time with the device 12, through web browsers, and/or sent in Internet emails. Furthermore, with the storage element, the processor has the ability to add new words or phrases to the database of sign language videos. For example, if a user wishes to record a signed, written, or spoken word or phrase, an input language of sign language, text, or voice may be captured on video. The user may then enter the corresponding input language in written or spoken form. This input may then be added to the database or storage element of the processor and accessed later for translation purposes or otherwise. The storage element is preferably an Internet server or database, or may be a conventional memory chip, such as RAM, a hard drive, or a flash drive, but may alternatively be any suitable device able to store information.

### 4. The First Preferred Embodiment

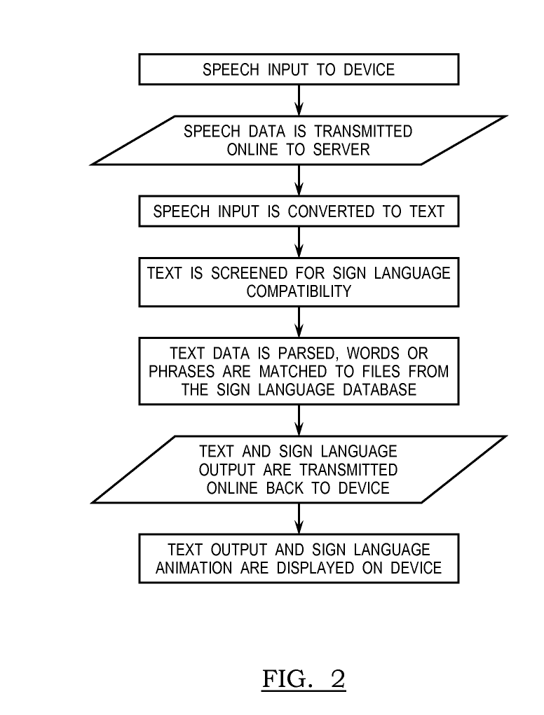

In a first preferred embodiment of the invention, as shown in FIG. 2, the system 10 includes an input element 14 of the second variation (a microphone), an output element 16 of the first variation (a screen), and a processor that receives the input language from the input element 14 in the form of spoken language, translates the input language to the output language of both written language and images of sign language, and transmits the output language to the output element 16. In this variation, the processor receives the spoken input language. The processor is preferably a remote server and the input language is transmitted over the Internet to the server. Once there, the spoken input language is preferably converted to natural language using standard speech recognition software or any other suitable method. The natural language is then parsed and converted into the grammar of the signed language. For example, if the input language is English and the signed language is American Sign Language, words such as ‘a,’ ‘an,’ ‘the,’ ‘am,’ and ‘is’ would be ignored since they are not grammatically required in ASL. The order of the words may also be rearranged to align with the word order in grammatically correct ASL. The sign language may alternatively be Pidgin Signed English (PSE), Signed English, Signing Exact English (SEE), or any other suitable signed language. Once the grammar is adjusted, the words in the sentence are matched to animations from the database. If a sign is unavailable for a word, the word may be finger spelled. Once each of the sign language animations is identified, they are assembled into one continuous animation. The ending of one animation is preferably blended into the beginning of the next animation to insure continuity between signs. The output language (the series of sign language animations) is then transmitted to the output element 16. The processor is preferably a remote server and the output language is streamed (or otherwise transmitted) over the Internet to the device 12 and displayed in a browser window in the output element 16 along with the written language output. By physically separating the device 12 and the processor, the system gains the benefits of a software-as-a-service (SaaS) arrangement (namely, the ease of updating the application and database, and the power of cloud computing).

### 5. The Second Preferred Embodiment

In a second preferred embodiment of the invention, the system 10 includes an input element 14 of the third variation (data input), an output element 16 of the first variation (a screen), and a processor that receives the input language from the input element 14 in the form of written language, translates the input language to the output language of images of sign language, and then transmits the output language to the output element 16. In this variation, the processor receives the written input language. The processor is preferably a remote server and the input language is preferably transmitted over the Internet to the server. Once there, the written language is then parsed and converted into the grammar of the signed language. All other steps are preferably the same as above in the first preferred embodiment.

### 6. The Third Preferred Embodiment

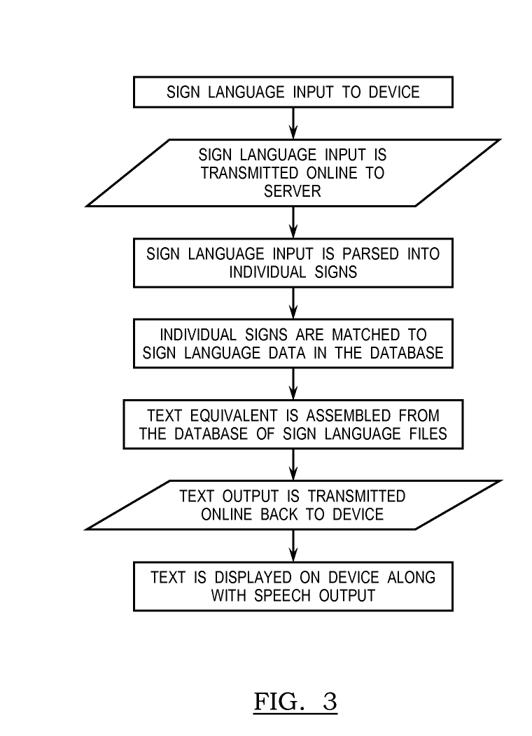

In a third preferred embodiment of the invention, as shown in FIG. 3, the system 10 includes an input element 14 of the first variation (a camera), an output element 16 of both the first variation (a screen) and the second variation (a speaker), and a processor that receives the input language from the input element 14 in the form of sign language, translates the input language to the output language of written language and spoken language, and transmits the output language to the output element 16. In this variation, the processor receives the sign language input. The processor is preferably a remote server and the input language is preferably transmitted over the Internet to the server. Once there, the input sign language is preferably parsed into individual signs and then converted to written language. The output language (the written or spoken language) is then transmitted to the output element 16. The processor is preferably a remote server and the output language is preferably streamed over the Internet to the device 12 and displayed in a browser window in the output element 16. The written language may be accompanied by the sign animations so the user can check for accuracy of the translation in both forms. If desired, the written language may also be converted into spoken language and the spoken language output will be transmitted to the speaker output element.

### 7. Method of Creating Images of Sign Language

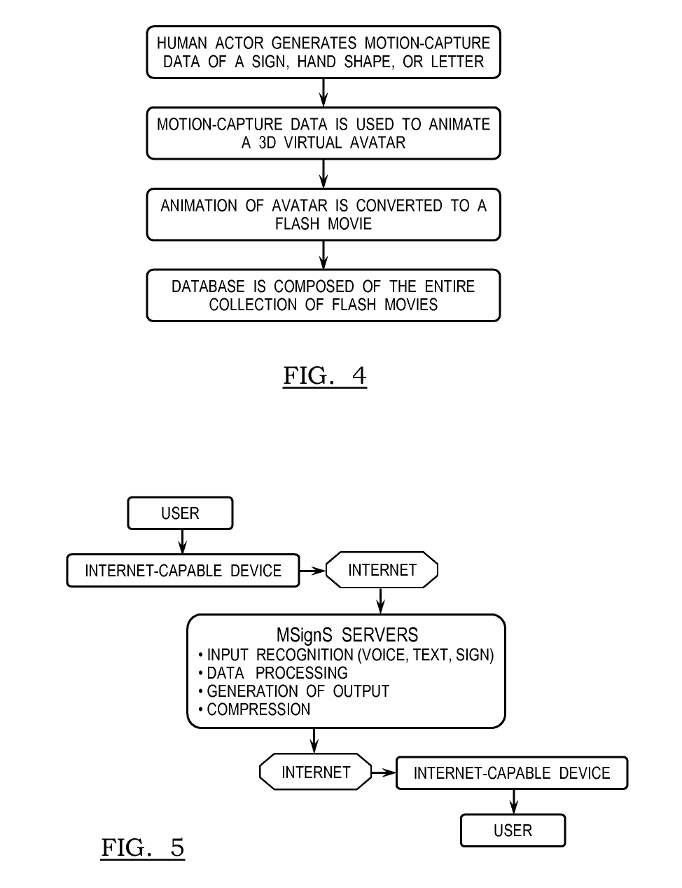

The invention further includes the method of creating the video images of sign language. As shown in FIG. 4, a first variation of the method begins with performing each sign individually using motion capture equipment. The equipment preferably consists of several markers placed around the person's hands and body. The movement of each marker is recorded as data in the motion capture, and looks like a cloud of points moving in space. This ‘point cloud’ becomes the basis for which a 3d character, known in the art as an avatar, is driven. The avatar further includes skin and clothing such that it is life like. The avatar follows the movements of the point cloud through space. The movement of the avatar is what the end user will see. It is preferably converted into an Adobe Flash animation, or any other suitable animation program and added to the processor server and/or database. Alternatively, the system may utilize any other suitable programming language or standard for creating graphics, such as OpenGL. The processor server and/or database preferably includes animations for words, hand shapes, letters of the alphabet, numbers, phrases, sounds, music, etc. Alternatively, the video images of sign language may be created and added to the database in any other suitable method. For example, sign language video may be added “on the fly” or while the translation system in use in the field. An input language of sign language may be captured on video and the user may then enter a corresponding input language in written or spoken form. This input may then be added to the database or storage element of the processor and accessed later for translation purposes or otherwise. Sign language images may also be added through a marker-less motion capture technology. One example of this technology uses multiple 2D video cameras to track the motion of the subject. The data output from each camera is fed into a processor, which maps every pixel of information and triangulates the location of the subject by seeing where the various camera images intersect.

Although omitted for conciseness, the preferred embodiments include every combination and permutation of the various translation systems, the various portable devices, the various input elements and input languages, the various output elements and output languages, the various processors, and the various processes and methods of creating and translating input and output languages.

As a person skilled in the art will recognize from the previous detailed description and from the figures and claim, modifications and changes can be made to the preferred embodiments of the invention without departing from the scope of this invention defined in the following claims.

I claim:

1. A method of translating an input language, the method comprising the steps of:
receiving the input language as audio information;
translating the input language into an output language, wherein the output language includes a series of the sign language images that correspond to the input language and that are coupled to one another such that the ending position of a first image is blended into the starting position of a second image; and
transmitting the output language.

2. The translation system of claim 1, wherein the step of translating the input language into an output language includes the steps of:
converting the input language to natural language using a speech recognition software;
parsing and converting the grammar of the natural language into sign language grammar; and
converting the natural language with sign language grammar into the series of sign language images.

3. The method of claim 1, wherein the series of the sign language images that correspond to the input language are coupled to one another by performing the steps of:
calculating the ending position of the first sign;
calculating the starting position of the second sign; and
interpolating the distance from the ending position of the first sign to the starting position of the second sign.

4. The method of claim 3, wherein the ending position of the first image is in a first location and the starting position of the second image is in a second location, and wherein the first location is different from the second location.

5. The method of claim 1, wherein the step of receiving the input language as audio information includes receiving the input language through an input element, wherein the input element is a microphone.

6. The method of claim 5, wherein the step of receiving the input language as audio information further includes receiving the input language from at least one of a hearing aid device, a telephone, a music player, a television, and a speaker system.

7. The method of claim 1, wherein receiving the input language as audio information includes receiving the input language as spoken language.

8. The method of claim 1, wherein receiving the input language as audio information includes receiving the input language as environmental sounds.

9. The method of claim 1, wherein the step of transmitting the output language includes transmitting the output language to an output element, wherein the output element is a screen.

10. The method of claim 9, wherein the screen has a first screen portion displaying a first output language, and a second screen portion displaying a second output language.

11. The method of claim 1, wherein the step of transmitting the output language includes transmitting the output language to an output element, wherein the output element is an Internet application.

12. The method of claim 1, wherein the step of transmitting the output language includes adjusting the output language to enable improved comprehension.

13. The method of claim 12, wherein a display speed of the output language is decreased and increased to enable improved comprehension.

14. The method of claim 1 wherein the output language further includes text data that corresponds to the input language.

15. A method of translating a language, the method comprising the steps of:
receiving input data in the form of text data;
translating the input data into an output language by performing the steps of:
converting the grammar of the text data into sign language grammar,
converting the text data with sign language grammar into a series of sign language images that correspond to the input data,
coupling the series of sign language images to one another by performing the steps of:
calculating an ending position of a first sign language image,
calculating a starting position of a second sign language image, and
interpolating the distance from the ending position of the first sign language image to the starting position of the second sign language image; and
transmitting the output language.

16. The method of claim 15, wherein the step of receiving input data in the form of text data includes receiving the input data through an input element, wherein the input element is a keyboard.

17. The method of claim 16, wherein the step of receiving input data in the form of text data includes the step of selecting the input data from text in an electronic document.

18. A method of translating an input language, the method comprising the steps of:
receiving the input language as visual information, wherein the visual information is a series of sign language images;
translating the input language into a first output language and a second output language by performing the steps of:
parsing the visual information of the input language into individual sign images,
converting the individual sign images into the first output language in the form of text data that corresponds to the input language, and
converting the text data into the second output language in the form of audio information that corresponds to the input language; and
transmitting the first output language and the second output language.

19. The method of claim 18, wherein the step of receiving the input language as visual information includes receiving the input language through an input element, wherein the input element is a camera that functions to record visual information.

20. The method of claim 18, wherein the step of receiving the input language as visual information includes receiving the input language through an input element, wherein the input element is motion capture equipment.

21. The method of claim 18, wherein the step of the first output language and the second output language includes transmitting the first output languages to a first output element and the second output language to a second output element, wherein the first output element is a screen that displays a first output language as text data and the second output element is a speaker that transmits second output language as audio information.

22. The method of claim 18, wherein the step of the first output language and the second output language includes transmitting the first output language to a first output element and the second output language to a second output element, wherein the output elements are coupled to an Internet application.

23. A translation system comprising:
a portable device, including:
an input element that receives an input language as audio information,
an output element that displays an output language as visual information, and
a communication element that receives the input language from the input element, transmits the input language, receives the output language, and transmits the output language to the output element;
a remote server, coupled to the communication element of the portable device, including:
a processor that receives the input language from communication element, translates the input language into the output language, and transmits the output language back to the communication element, and
a storage element, coupled to the processor, that stores a database of sign language images,
wherein the output language is a series of the sign language images that correspond to the input language and that are coupled to one another by the processor such that the ending position of a first image is blended into the starting position of a second image.
